(19) United States
(12) Patent Application Publication
(10) Pub. No.: US 2008/0253374 A1
(43) Pub. Date: Oct. 16, 2008

(54) Apparatus and method for communicating with receiving end via internet

(75) Inventor: Chang-Hung Lee, Dounan Township (TW)

Correspondence Address: BIRCH STEWART KOLASCH & BIRCH, PO BOX 747, FALLS CHURCH, VA, 22040-0747, US

(73) Assignee: Qisda Corporation

(21) Appl. No.: 12/081,077

(22) Filed: Apr. 10, 2008

(30) Foreign Application Priority Data
Apr. 13, 2007 (TW) 096113153

(51) Int. Cl. H04L 12/56

(52) U.S. Cl. 370/392

(57) ABSTRACT

The invention provides a method for a transmitting end to communicate with a receiving end, which is assigned with an IP address, via the Internet. The method of the invention includes the steps of: the transmitting end receives an information stream from a DVB-H network; the information stream contains a DVB-H packet header and a datagram, which contains an IP packet header and an IP packet payload. Additionally, the method of the invention further includes the steps of: the transmitting end decodes the information stream to remove the DVB-H packet header and obtains the datagram, then it writes the IP address of the receiving end in the IP packet header; and then the transmitting end transports the datagram with the IP address of the receiving end to the receiving end via the Internet.

### BACKGROUND OF THE INVENTION

1. Field of the Invention

The invention relates to an apparatus and a method for communicating with a receiving end via the Internet.

2. Description of the Prior Art

In the field of television science and technology, traditional analog television transmission has been gradually replaced by digital television transmission. The main reason of such trend is that digital television transmission has more advantages than traditional analog television transmission, such as better video and audio quality, and more efficient use of the frequency band. Accordingly, the digital television transmission can transmit more television channels within the same frequency band.

European digital TV system, called the Digital Video Broadcasting (DVB), has been used for several years, and the system is established by both the European Broadcasting Union (EBU) and the European Telecommunication Standards Institute (ETSI). Besides the presently commonly used European standards, there are two familiar digital broadcasting standards. One of them is Advanced Television System Committee (ATSC) standards, which is used in Canada and Korea too, beside America; the other one is the Terrestrial Integrated Services Digital Broadcasting (ISDB-T) standards established by the Japanese. Presently, this set of standards is used in Japan only.

Please refer to FIG. 1. FIG. 1 is a schematic diagram illustrating the DVB system in the prior art. As shown in FIG. 1, the prior DVB operator 51 can make agreement with an information producer 53a or an information transmitter 53b to receive information from the information producer 53a or the information transmitter 53b, such as movie, news, music video, or other information capable of being transmitted to the DVB network 55.

When the DVB operator 51 receives the information from the information producer 53a or the information transmitter 53b, the DVB operator 51 establishes a transmission schedule 511 to lead to a suitable way for arranging the information. When the DVB operator 51 has arranged the information wanted to be transmitted to the DVB network 55, the information will be inputted into a DVB server 513. The DVB server 513 is in charge of encoding the information as an information stream according to the standard DVB transmission encoding, such as MPEG2/S. After finish, the information stream is transmitted to the DVB network 55, and the user end 57 receives the information stream from the DVB network 55 via a receiving apparatus 571, such as a digital TV, and broadcasts the information stream after decoding.

However, either because the channels of each country or area are different or because of the different limitations of different broadcasting areas, it is difficult for the user of the present digital TV broadcasting to watch the internal digital TV channels or the in-area digital TV channels across nations or areas, and makes it inconvenient to use. For example, lives in Taiwan, the user can not watch the digital TV channels from Taiwan when he is on a business trip to Germany.

### SUMMARY OF THE INVENTION

Accordingly, a scope of the invention is to provide an apparatus and a method for communicating with a receiving end via the Internet. Particularly, the apparatus and method of the invention can solve the above-mentioned problem, so as to enable the user to watch domestic or in-area digital TV channels across nations or areas.

According to a preferred embodiment, a method for a transmitting end communicating with a receiving end via the Internet is provided, and the receiving end has an IP address. The method includes the following steps:

First, the transmitting end receives an information stream from a Digital Video Broadcasting-Handheld (DVB-H) network, and the information stream includes a DVB-H packet header and a datagram. The datagram includes an IP packet header and an IP packet payload, and the IP packet payload complies with International Telecommunication Union Telecommunication Standardization Sector (ITU-T) H.264 standard. Afterwards, the transmitting end decodes the information stream to remove the DVB-H packet header to obtain the datagram, and writes the IP address of the receiving end into the IP packet header. Finally, the transmitting end transmits the datagram with the IP address of the receiving end to the Internet.

According to another preferred embodiment of the invention, an apparatus for communicating with a receiving end via the Internet is provided, and the receiving end has an IP address. Besides, the apparatus includes a receiving device, a processing module, and a first transceiver.

The receiving device is for receiving an information stream from a DVB-H network, wherein the information stream includes a DVB-H packet header and a datagram, and the datagram includes an IP packet header and an IP packet payload complying with ITU-T H.264 standard. The processing module is for decoding the information stream to remove the DVB-H packet header to obtain the datagram, and writes the IP address of the receiving end into the IP packet header. Furthermore, the first transceiver is for transmitting the datagram with the IP address of the receiving end to the Internet.

The advantage and spirit of the invention may be understood by the following recitations together with the appended drawings.

### BRIEF DESCRIPTION OF THE APPENDED DRAWINGS

FIG. 1 is a schematic diagram illustrating a DVB system in the prior art.

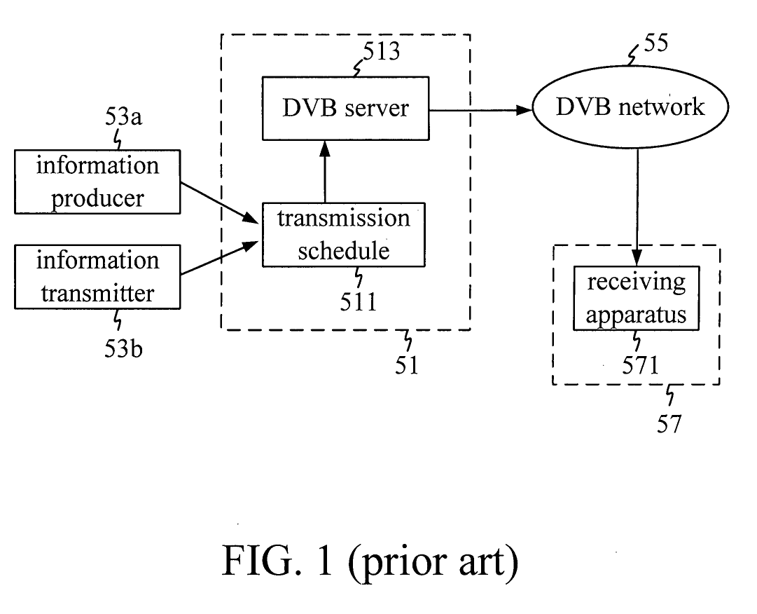

FIG. 2A is a flow chart illustrating a method for a transmitting end communicating with a receiving end via the Internet according to a preferred embodiment of the invention.

FIG. 2B is a schematic diagram illustrating a DVB-H information stream.

FIG. 3A is a flow chart illustrating a method according to an embodiment of the invention.

FIG. 3B is a flow chart illustrating a method according to an embodiment of the invention.

FIG. 3C is a flow chart illustrating a method according to an embodiment of the invention.

FIG. 4 is a function block diagram illustrating an apparatus for communicating with a receiving end via the Internet according to a preferred embodiment of the invention.

FIG. 5 is a function block diagram illustrating an apparatus according to an embodiment of the invention.

FIG. 6 is a function block diagram illustrating a receiving end according to an embodiment of the invention.

### DETAILED DESCRIPTION OF THE INVENTION

The invention provides an apparatus and a method for communicating with a receiving end via the Internet. According to the invention, several embodiments are disclosed as follows.

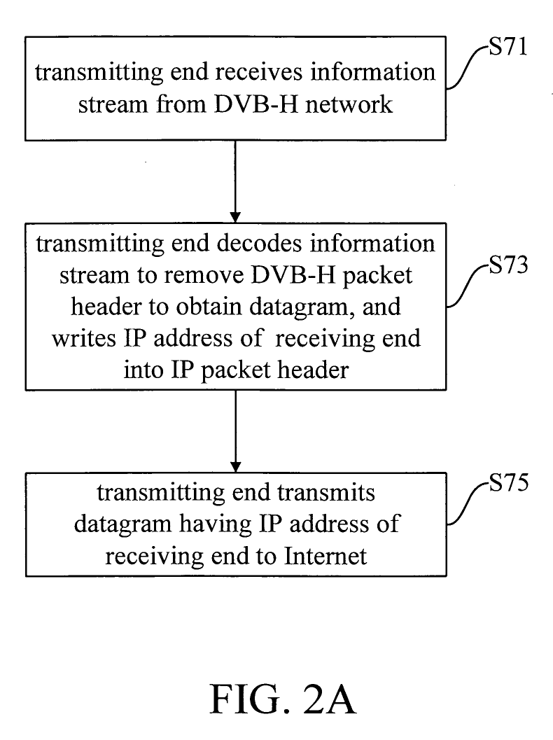

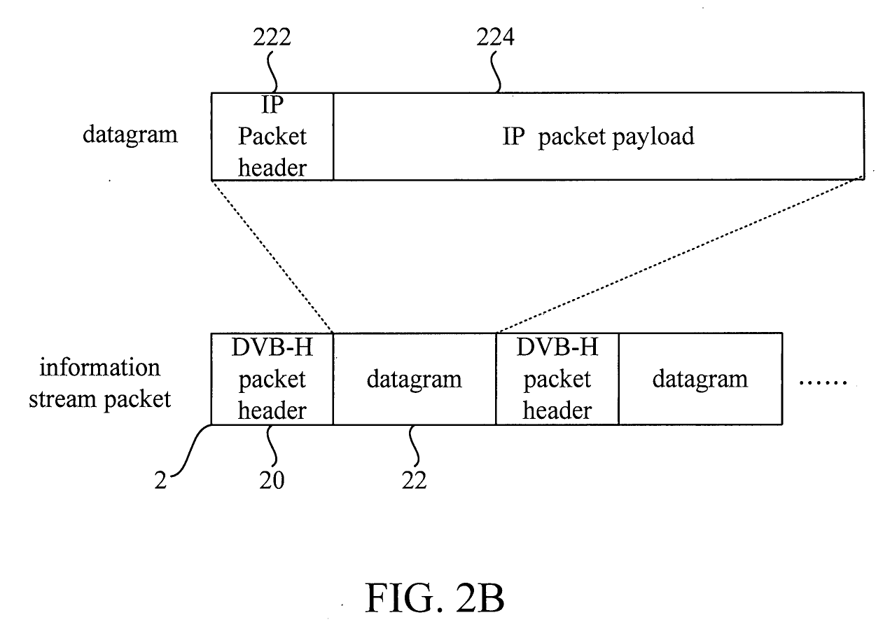

Please refer to FIG. 2A and FIG. 2B. FIG. 2A is a flow chart illustrating a method for a transmitting end communicating with a receiving end via the Internet according to a preferred embodiment of the invention; and FIG. 2B is a schematic diagram illustrating a Digital Video Broadcasting-Handheld (DVB-H) information stream. Furthermore, the receiving end has an IP address. As shown in FIG. 2A, the method includes the following steps:

First, in step S71, the transmitting end receives the information stream 2 from a DVB-H network, and the information stream 2 includes a DVB-H packet header 20 and a datagram 22. The datagram 22 includes an IP packet header 222 and an IP packet payload 224, and the IP packet payload 224 complies with International Telecommunication Union Telecommunication Standardization Sector (ITU-T) H.264 standard.

Afterwards, in step S73, the transmitting end decodes the information stream 2 to remove the DVB-H packet header 20 to obtain the datagram 22, and writes the IP address of the receiving end into the IP packet header 222. Finally, in step S75, the transmitting end transmits the datagram 22 with the IP address of the receiving end to the Internet.

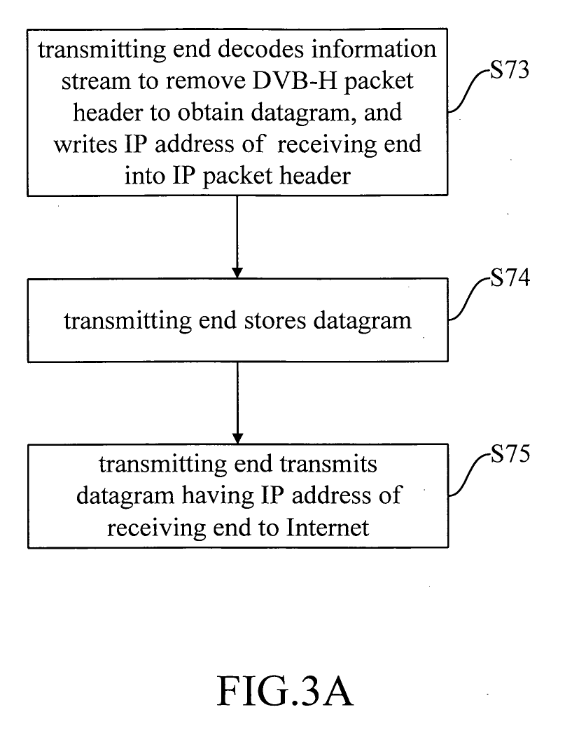

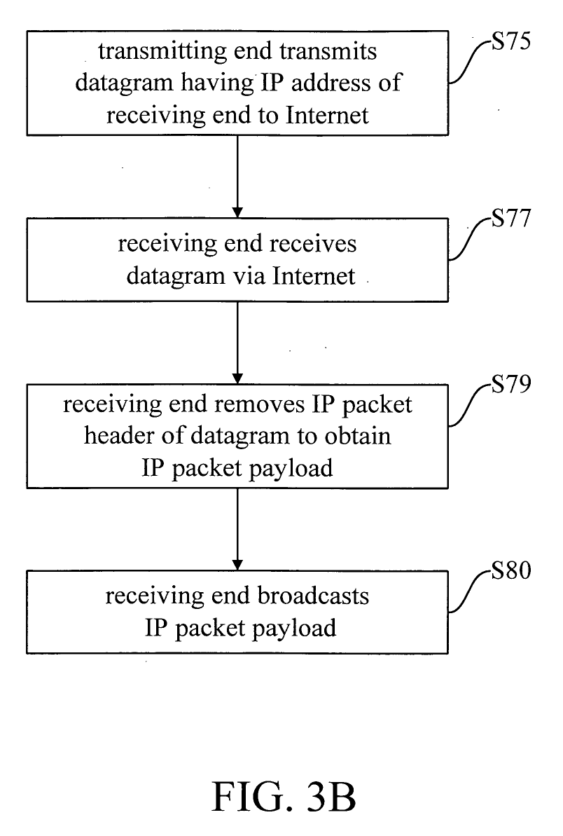

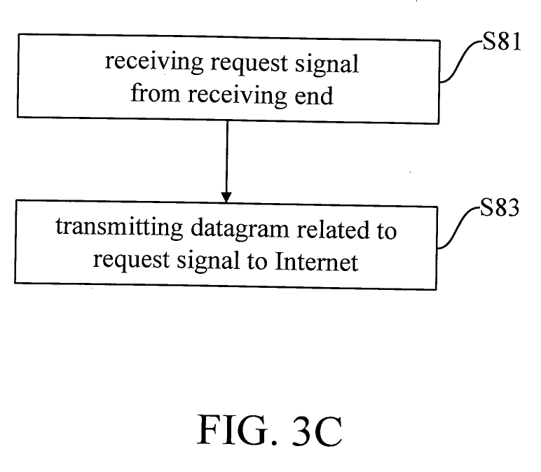

Please refer to FIG. 3A. FIG. 3A is a flow chart illustrating a method according to an embodiment of the invention. In this embodiment, the method of the invention further includes step S74: before the transmitting end transmits the datagram to the Internet, the transmitting end temporarily stores the datagram.

Please refer to FIG. 3B. FIG. 3B is a flow chart illustrating a method according to an embodiment of the invention. In this embodiment, the method of the invention further includes the following steps: in step S77, the receiving end receives the datagram via the Internet; in step S79, the receiving end removes the IP packet header of the datagram to obtain the IP packet payload; and in step S80, the receiving end broadcasts the IP packet payload. In practice, the transmitting end transmits the datagram to the receiving end via the Internet and is performed through peer to peer transmission.

Please refer to FIG. 3C. FIG. 3C is a flow chart illustrating a method according to an embodiment of the invention. In this embodiment, the method further includes the following steps: in step S81, receiving a request signal from the receiving end; and in step S83, transmitting the datagram related to the request signal to the Internet.

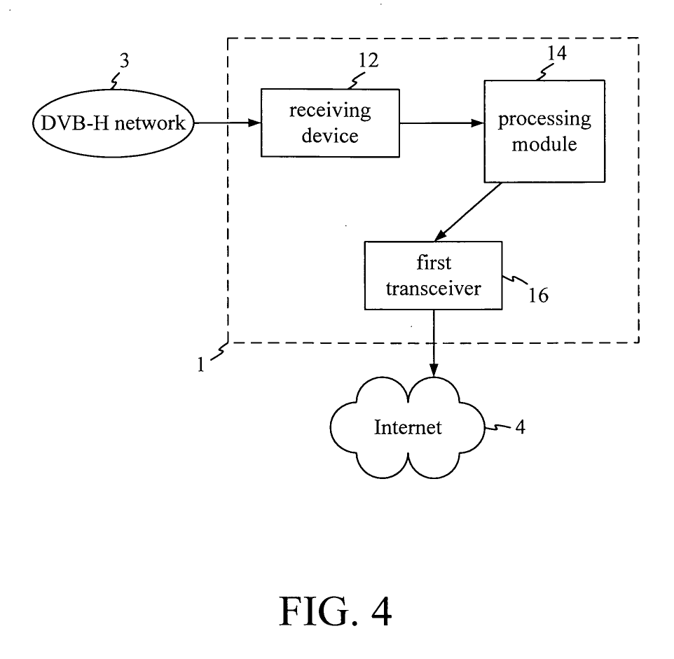

Please refer to FIG. 4. FIG. 4 is a function block diagram illustrating an apparatus for communicating with a receiving end via the Internet according to a preferred embodiment of the invention. It should be noticed that the receiving end has an IP address. As shown in FIG. 4, the apparatus 1 of the invention includes a receiving device 12, a processing module 14, and a first transceiver 16.

Furthermore, the receiving device 12 can be used for receiving an information stream from a DVB-H network 3. Besides, please refer to FIG. 2B, wherein the information stream 2 includes a DVB-H packet header 20 and a datagram 22. The datagram 22 includes an IP packet header 222 and an IP packet payload 224, and the IP packet payload 224 complies with ITU-T H.264 standard. The processing module 14 is for decoding the information stream to remove the DVB-H packet header 20 to obtain the datagram 22, and writing the IP address of the receiving end into the IP packet header 222. Besides, the first transceiver is used for the transmitting of the datagram 22 with the IP address of the receiving end to the Internet 4.

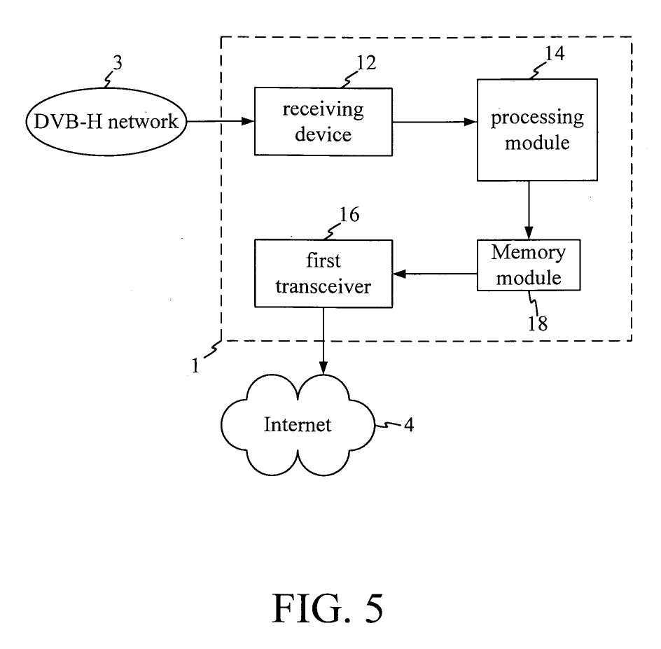

Please refer to FIG. 5. FIG. 5 is a function block diagram illustrating an apparatus according to an embodiment of the invention. As shown in FIG. 5, the apparatus 1 of the invention further includes a memory module 18, which is connected to the processing module 14, for temporarily storing the datagram before the apparatus 1 transmitting the datagram to the Internet 4. Besides, in this embodiment, the first transceiver 16, connected to the memory module 18, is used for the transmitting of the datagram stored in the memory module 18 to the Internet 4.

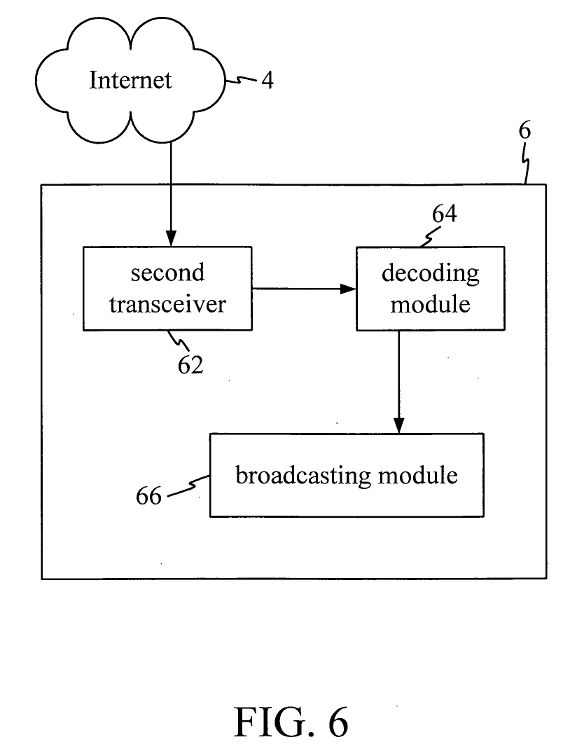

In an embodiment, the receiving end is an electronic device, such as a mobile phone, a PDA, and so on. Furthermore, in practice, the electronic device can receive the datagram via the Internet through peer to peer transmission. Please refer to FIG. 6. FIG. 6 is a function block diagram illustrating a receiving end according to an embodiment of the invention. As shown in FIG. 6, the receiving end 6 includes a second transceiver 62, a decoding unit 64, and a broadcasting module 66.

The second transceiver 62 is for receiving the datagram via the Internet 4, and the second transceiver 62 can transmit a request signal to the first transceiver 16. The decoding unit 64 can be used for removing the IP packet header of the datagram to obtain the IP packet payload. The broadcasting module 66 can be used for broadcasting the IP packet payload.

In practice, when the first transceiver 16 receives the request signal, the first transceiver 16 can transmit the datagram related to the request signal to the Internet 4, and then the second transceiver 62 receives the datagram via the Internet 4.

From what was mentioned above, the apparatus and method enable users to watch digital TV channels across nations or areas via Internet, so as to solve the problems in the prior art. Besides, because the IP packet payload of the invention complies with ITU-T H.264 standard, the occupying frequency band is smaller so that more information can be transmitted within the fixed frequency band.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for a transmitting end communicating with a receiving end via the Internet, the receiving end assigned with an IP address, the method comprising the following steps:
the transmitting end receiving an information stream from a Digital Video Broadcasting-Handheld (DVB-H) network, the information stream comprising a DVB-H packet header and a datagram, the datagram comprising an IP packet header and an IP packet payload, and the IP packet payload complying with International Telecommunication Union Telecommunication Standardization Sector (ITU-T) H.264 standard;
the transmitting end decoding the information stream to remove the DVB-H packet header to obtain the datagram, and writing the IP address of the receiving end into the IP packet header; and
the transmitting end transmitting the datagram with the IP address of the receiving end to the Internet.

2. The method of claim 1, further comprising the following step:
before the transmitting end transmitting the datagram to the Internet, the transmitting end temporarily storing the datagram.

3. The method of claim 1, further comprising the following steps:
the receiving end receiving the datagram via the Internet;
the receiving end removing the IP packet header of the datagram to obtain the IP packet payload; and
the receiving end broadcasting the IP packet payload.

4. The method of claim 1, wherein the transmitting end transmitting the datagram to the receiving end via the Internet and is performed through peer to peer transmission.

5. The method of claim 1, further comprising the following steps:
receiving a requested signal from the receiving end; and
transmitting the datagram related to the requested signal to the Internet.

6. An apparatus for communication with a receiving end via the Internet, and the receiving end assigned with an IP address, the apparatus comprising:
a receiving device, for receiving an information stream from a DVB-H network, the information stream comprising a DVB-H packet header and a datagram, the datagram comprising an IP packet header and an IP packet payload, and the IP packet payload complying with ITU-T H.264 standard;
a processing module, for decoding the information stream to remove the DVB-H packet header to obtain the datagram, and writing the IP address of the receiving end into the IP packet header; and
a first transceiver, for transmitting the datagram with the IP address of the receiving end to the Internet.

7. The apparatus of claim 6, further comprising:
a memory module, connected to the processing module, for temporarily storing the datagram before the apparatus transmitting the datagram to the Internet;
wherein the first transceiver is connected to the memory module, for transmitting the datagram stored in the memory module to the Internet.

8. The apparatus of claim 6, wherein the receiving end is an electronic device.

9. The apparatus of claim 8, wherein the receiving end receives the datagram via the Internet through peer to peer transmission.

10. The apparatus of claim 8, wherein the receiving end further comprising:
a second transceiver, for receiving the datagram via the Internet, and the second transceiver sending a request signal to the first transceiver;
a decoding unit, for removing the IP packet header to obtain the IP packet payload; and
a broadcasting module, for broadcasting the IP packet payload;
wherein when the first transceiver receiving the request signal, the first transceiver transmitting the datagram corresponding to the request signal to the Internet, and the second transceiver receiving the datagram via the Internet.
